(19) United States
(12) Patent Application Publication
(10) Pub. No.: US 2009/0101562 A1
(43) Pub. Date: Apr. 23, 2009

(54) FILTER FOR A MEDICAL INSTRUMENT ASSEMBLY

(76) Inventor: Brian Newton, Jamestown, NC (US)

Correspondence Address: SMITH MOORE LEATHERWOOD LLP, P.O. BOX 21927, GREENSBORO, NC, 27420, US

(21) Appl. No.: 12/208,293

(22) Filed: Sep. 10, 2008

Related U.S. Application Data
(60) Provisional application No. 60/971,100, filed on Sep. 10, 2007.

(51) Int. Cl. B01D 35/30; B01D 50/00

(52) U.S. Cl. 210/232; 55/385.1

(57) ABSTRACT

A liquid filter capable of filtering liquid, such as water, that is supplied to a medical instrument assembly. The liquid filter is adapted for connection to the medical instrument assembly, a liquid source, and/or liquid supply tubing. A gas filter capable of filtering gas supplied to a medical instrument assembly, the gas filter being adapted for connection to the medical instrument assembly, a gas source, and/or gas supply tubing. A liquid and/or gas filter capable of filtering liquid and/or gas, respectively, the liquid and/or gas filter being adapted for connection to a medical instrument assembly, a gas source, a liquid source, gas supply tubing, and/or liquid supply tubing. The medical instrument may be an invasive medical instrument, such as an endoscope.

This application claims the benefit of U.S. Provisional Application No. 60/971,100, filed Sep. 10, 2007.

### BACKGROUND OF THE INVENTION

The present invention relates to a liquid and/or gas filter for a medical instrument assembly.

Some medical instruments are connected to a liquid (such as water) and/or gas source (such as an oxygen source) so that liquid and/or gas can be used with the instrument during its operation. For example, invasive instruments such as endoscopes are often connected to a liquid and/or gas source to allow liquid and/or gas to be directly provided to the optic head or distal end of the endoscope during use. In some instances, it is desirable that the liquid and/or gas being supplied to the medical instrument be filtered or sterile to prevent bacteria and other contaminants from entering into the patient's body.

Accordingly, there is a need in the art for a liquid and/or gas filtration device that can be used to deliver filtered and/or sterile liquid and/or gas to a medical instrument assembly during operation of the instrument.

### BRIEF DESCRIPTION OF THE FIGURES

The present invention is better understood by a reading of the Detailed Description of the Invention along with a review of the drawings, in which:

FIG. 1 is a schematic view of a point of use filter that is adapted for connection to a medical instrument and water supply tubing.

FIG. 2 is a schematic view of a point of use filter that is adapted for connection to a cap of a water supply on one end and water supply tubing on the other end.

FIG. 3 is a schematic view of a filter that is integrally formed with water supply tubing that supplies water to a medical instrument.

FIG. 4 is a schematic view of a filter that is integrally formed on one end of water supply tubing and is adapted for connection to a medical instrument.

FIG. 5 is a schematic view of a filter that is integrally formed on one end of water supply tubing and is adapted for connection to a cap of a water supply.

FIG. 6 is a schematic view of filter that is adapted for connection within a cap of a water supply that supplies water to a medical instrument.

### DETAILED DESCRIPTION OF THE INVENTION

The present invention provides a means for delivering filtered and/or sterile liquid and/or gas to a medical instrument assembly, such as an invasive instrument.

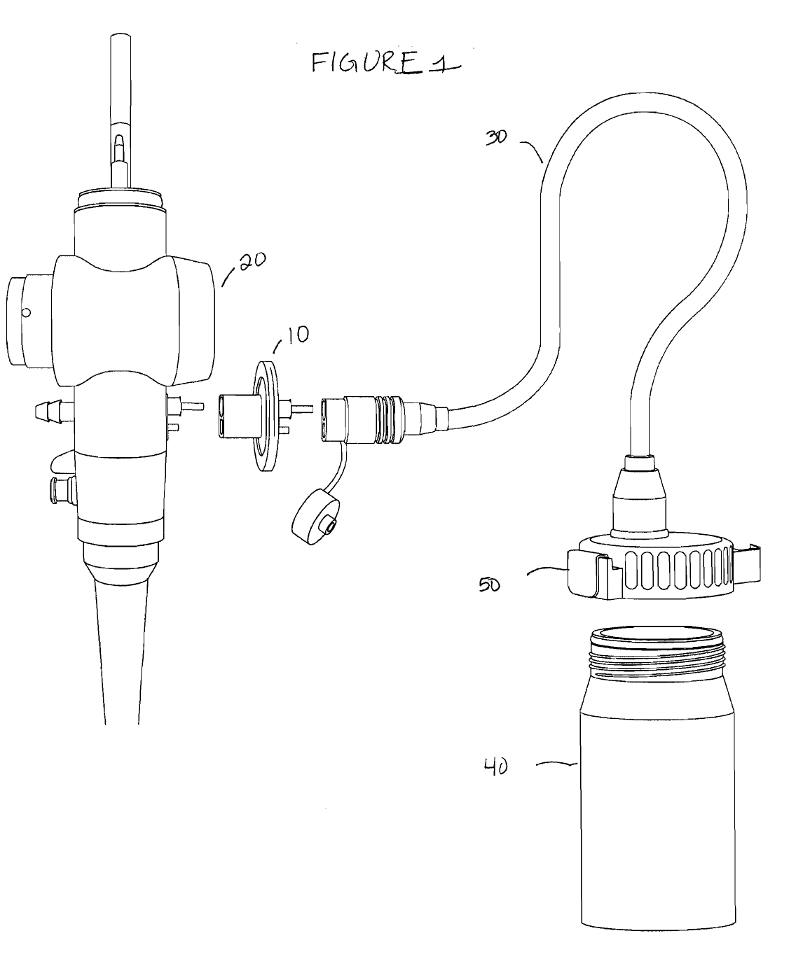

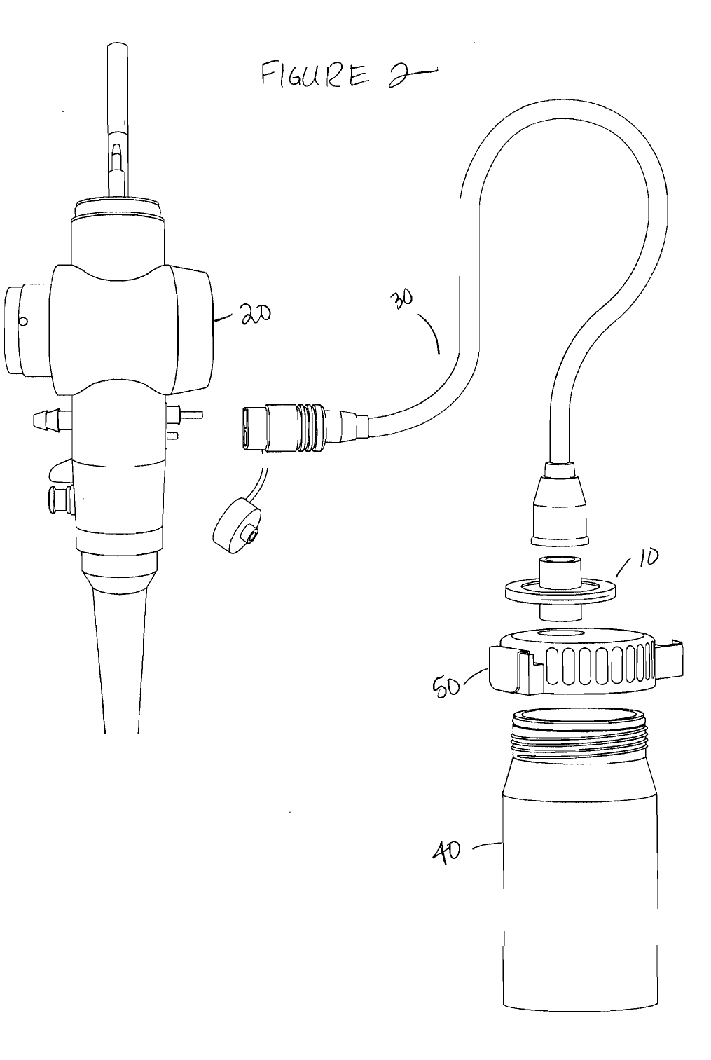

In one embodiment of the invention, a stand alone liquid and/or gas filter unit is provided that may be configured to connect to a medical instrument assembly, a liquid source, a gas source, liquid supply tubing, and/or gas supply tubing. In one aspect of the invention, as shown in FIG. 1, the stand alone filter 10 may be configured to connect to the medical instrument assembly on one end, such as an endoscope 20, and liquid and/or gas supply tubing 30 on the other end. In the aspect shown in FIG. 2, the stand alone filter 10 may be adapted for connection to a liquid and/or gas supply on one end, such as the cap 50 of a water bottle 40, and liquid and/or gas supply tubing 30 on the other end. The stand alone filter 10 may also be adapted to connect to liquid and/or gas supply tubing 30 on both ends.

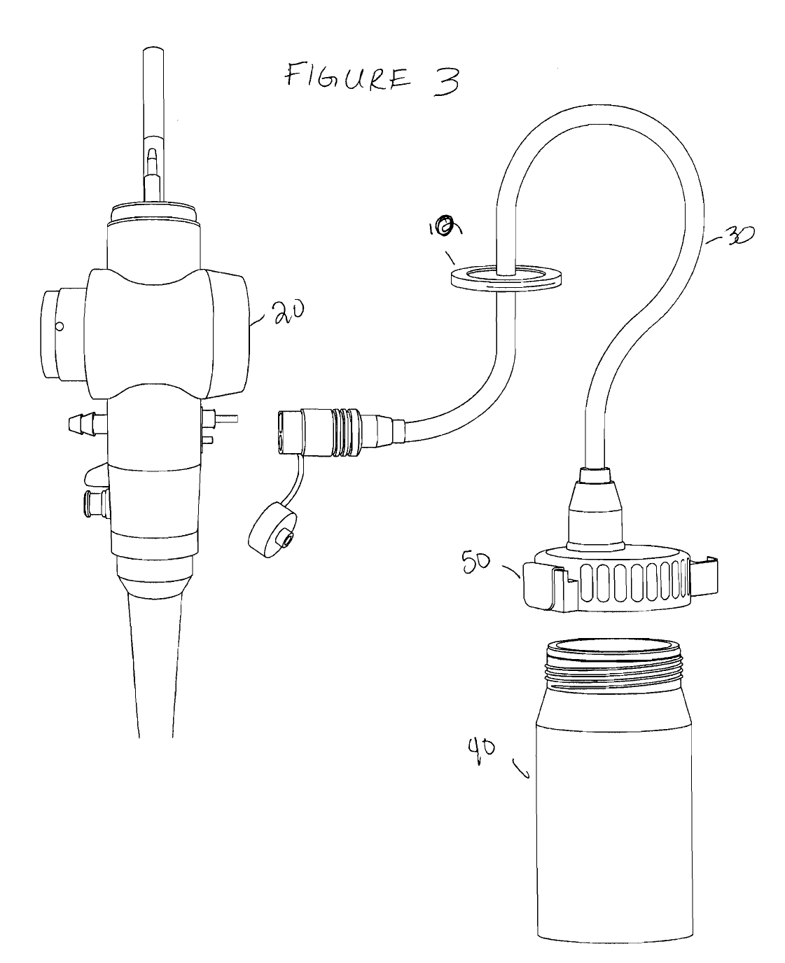

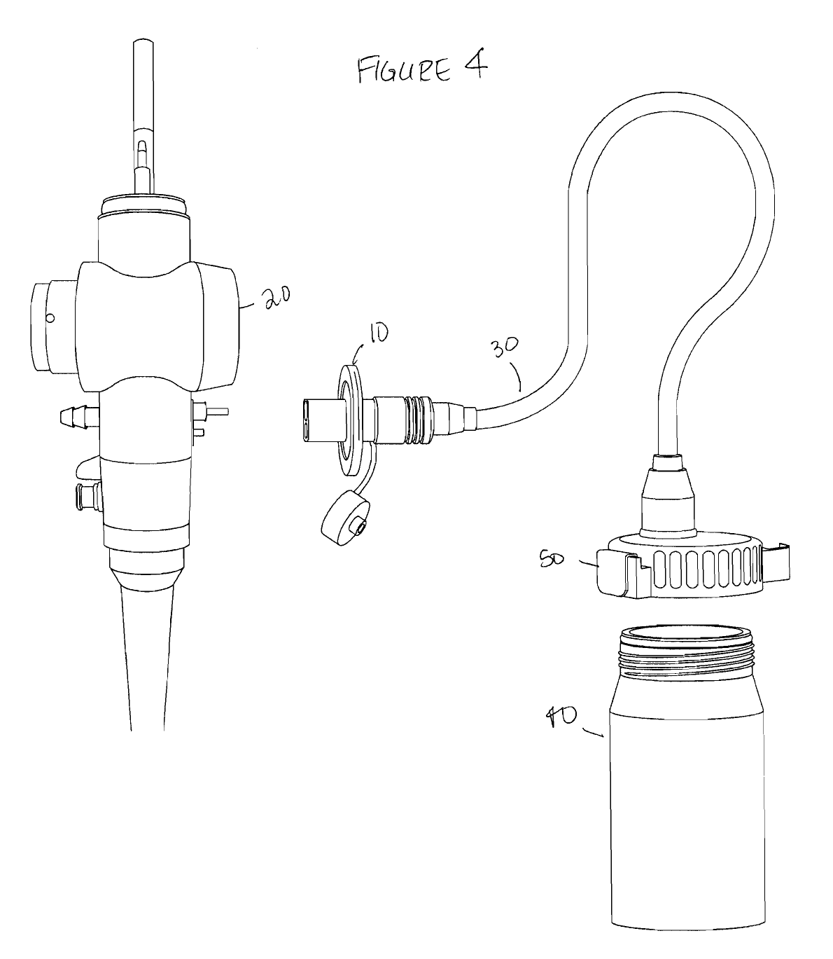

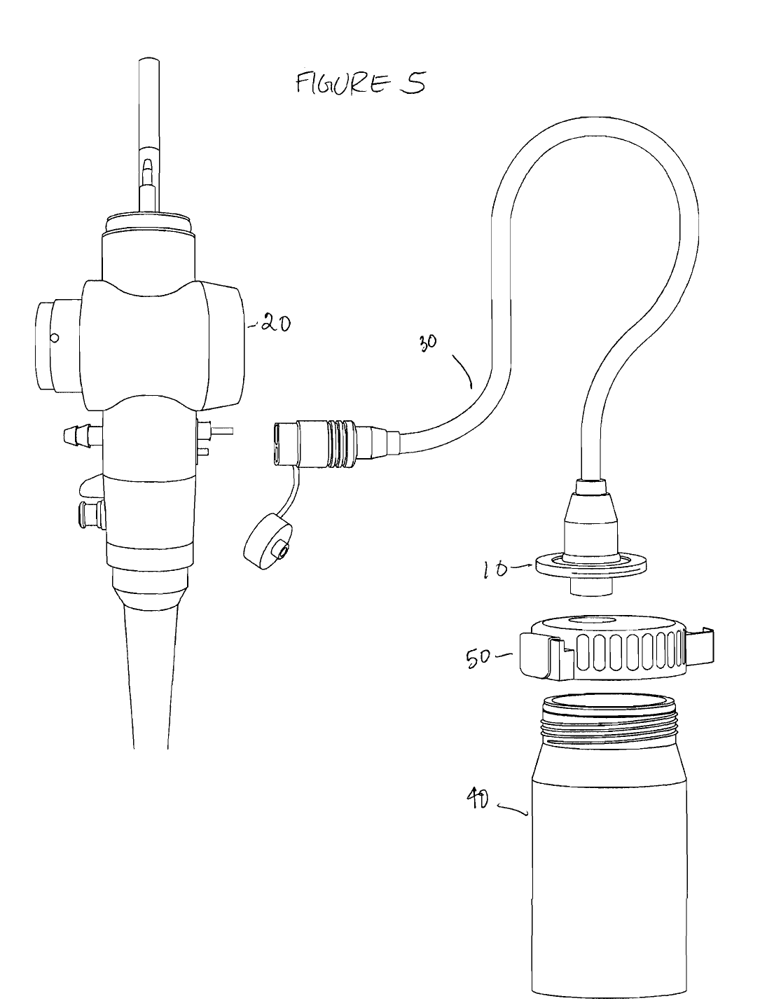

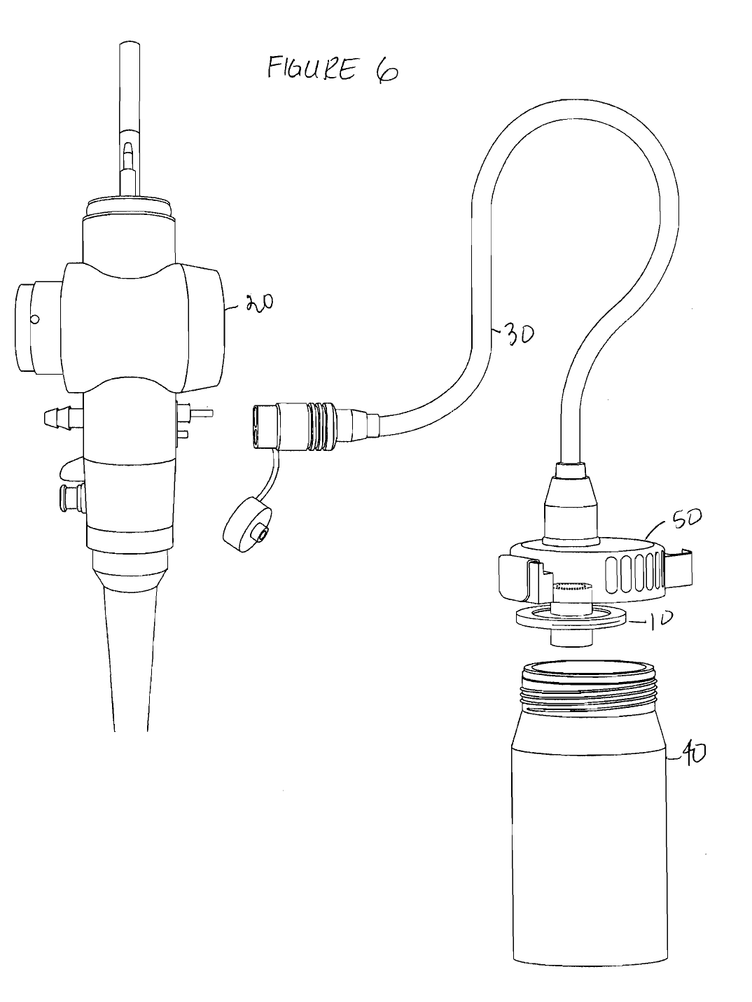

In a second embodiment of the invention, a liquid and/or gas filter may be integrally formed with a liquid source, a gas source, liquid supply tubing, and/or gas supply tubing. In the aspect shown in FIG. 3, the filter 10 may be integrally formed within liquid and/or gas supply tubing 30 that supplies liquid and/or gas to the medical instrument assembly 20. In the aspect shown in FIG. 4, the filter 10 may be integrally formed on one end of the liquid and/or gas supply tubing 30 and may be adapted for connection to the medical instrument assembly 20 on the other end. In the aspect shown in FIG. 5, the filter 10 may be integrally formed on one end of liquid and/or gas supply tubing 30 and may be adapted for connection to a liquid and/or gas supply on the other end, such as the cap 50 of a water bottle 40. In the aspect shown in FIG. 6, the filter 10 may be disposed within a cap 50 of a liquid supply source, such as a water bottle 40. In this aspect of the invention, the filter 10 may include screw threads to enable the filter 10 to screw into the cap 50. The filter 10 may also be integrally formed on top of or within the liquid bottle cap 50.

In another embodiment of the present invention, the filter unit may be adapted to connect to additional filters on one or both sides. So, for example, multiple liquid filters and/or gas filters can be connected to one another.

In any of the forgoing embodiments and aspects of the invention, a filter adaptor may be provided to aid in connecting either side of the filter to the relevant parts of the medical instrument assembly.

The liquid and/or gas filter described in the embodiments above may be a hollow-fiber, membrane or other media type filter such as to filter contaminants from the liquid and/or gas. In one aspect of the invention, the filter may output sterile liquid such as with a 0.2 micron media. In another aspect of the invention, the filter and/or tubing associated with the filter for attaching to the medical instrument assembly may allow flow in only one direction to prevent the backflow of liquid and/or gas. The filter may be configured such that the PSI/flow rate of the liquid and/or gas is compatible with the operator's needs for the medical instrument assembly.

The filter as described above may be used in connection with disposable, reusable, and/or resposable (reusable for a short term and then disposable) liquid bottles and/or tubing. The filter may be sterilized between uses when it is reusable or resposable.

Certain modifications and improvements will occur to those skilled in the art upon a reading of the foregoing description. For example, it should be understood that the filtration assembly of the present invention may be connected to or integrally formed with any type of liquid and/or gas supply source, such as a bottle, bag, or machine. Similarly, the filtration assembly may be adapted to deliver filtered and/or sterile liquid and/or gas to any part of the medical instrument assembly, including the instrument itself and/or any attachments to the instrument. All such modifications and improvements of the present invention have been deleted herein for the sake of conciseness and readability.

What is claimed is:

1. A liquid filter capable of filtering liquid supplied to a medical instrument assembly, the liquid filter being adapted for connection to the medical instrument assembly, a liquid source, and/or liquid supply tubing.

2. A gas filter capable of filtering gas supplied to a medical instrument assembly, the gas filter being adapted for connection to the medical instrument assembly, a gas source, and/or gas supply tubing.

3. A liquid and/or gas filter capable of filtering liquid and/or gas, respectively, the liquid and/or gas filter being adapted for connection to a medical instrument assembly, a gas source, a liquid source, gas supply tubing, and/or liquid supply tubing.
